(19) United States
(12) Patent Application Publication
(10) Pub. No.: US 2026/0004193 A1
(43) Pub. Date: Jan. 1, 2026

(54) METHOD AND SYSTEM FOR GENERATING TEXT-BASED HIGH-RESOLUTION 3D CONTENTS

(71) Applicant: LG MANAGEMENT DEVELOPMENT INSTITUTE CO., LTD., Seoul (KR)

(72) Inventors: Gunhee LEE, Seoul (KR); Honglak LEE, Seoul (KR)

(21) Appl. No.: 19/252,493

(22) Filed: Jun. 27, 2025

(30) Foreign Application Priority Data
Jun. 27, 2024 (KR) 10-2024-0084850
Sep. 13, 2024 (KR) 10-2024-0126199

(51) Int. Cl. G06N 20/00; G06T 17/20

(52) U.S. Cl. CPC G06N 20/00; G06T 17/20

(57) ABSTRACT

A method and a computing system including a memory and a processor learn a content generation model. The method may include preparing a training data set including a plurality of pairs of contents and captions, learning a first machine learning model to restore the contents from a low-dimensional latent code, learning a second machine learning model to output a latent code for a text embedding by learning relationship between text embeddings and latent codes of the pairs of the contents and the captions, and combining the first machine learning model and the second machine learning model. The content is implicit data which is function-based 3D shape data.

### CROSS-REFERENCE TO RELATED APPLICATIONS

This application claims the benefit of and priority to Korean Patent Application No. 10-2024-0084850, filed on Jun. 27, 2024, and Korean Patent Application No. 10-2024-0126199, filed on Sep. 13, 2024, the entire disclosures of which are hereby incorporated herein by reference in their entireties.

### BACKGROUND

### Field

The present disclosure generally relates to a method and a system for generating text-based high-resolution 3-dimensional (3D) contents. More specifically, some embodiments of the present disclosure may relate to a method and a system for generating high-resolution 3D contents corresponding to text input by a user.

### Description of Related Art

A 3D shape generation technology is one of important research topics in fields of computer graphics and artificial intelligence. In particular, a technology for automatically generating 3D contents through a text input has recently attracted attention. Existing 3D content generation is a complex and time-consuming task, and requires a professional 3D modeling technology and expensive software. This conventional approach has caused limitations in quickly visualizing creative ideas.

In recent years, as artificial intelligence and deep learning have been developed, text-to-image generation models have been remarkably developed, and images may be automatically generated through text description input by users in a natural language. This text-to-image generation has greatly improved automation of 2D content generation as large-scale datasets and powerful diffusion models have been developed. However, some technical limitations still exist in text-to-3D content generation.

An existing text-to-geometry generation technology mainly relies on categorical models of 3D objects, thereby limiting a range of objects that may be generated. Since these models are trained only for specific classes, the existing text-to-geometry generation technology may have difficulties in generating new classes of objects, and high-resolution and precise 3D shapes and texture representations are limited. In particular, due to a lack of data and computational resources which are required for high-resolution 3D content generation, there may be limitations in generating only low-resolution 3D objects or in reproducing high-frequency geometric details in complex shapes.

Recently, research has been performed to utilize a pre-trained text-image diffusion model as powerful prior information for 3D generation. However, this research may have limitations in generating high-resolution 3D shapes since the model is trained on low-resolution images. In addition, a 3D representation method based on a Neural Radiance Field (NeRF) that utilizes an inefficient multilayer perceptron (MLP) structure rapidly increases memory usage and computational costs at high resolutions. Consequently, it is very difficult to generate practical high-resolution 3D.

Therefore, it is desirable to introduce a new approaching method for automatically generating high-resolution and detailed 3D contents through a text input.

### SUMMARY

In order to overcome the technical limitations, some embodiments of the present disclosure may aim to provide a method and a system for generating intended high-resolution and precise 3D shape contents only by inputting text through a machine learning model trained to restore 3D contents with a small amount of data processing.

However, technical aspects to be achieved by the present disclosure and embodiments of the present disclosure are not limited to the above-described technical aspects, and other technical aspects may exist.

According to an embodiment, there is provided a method in which a computing system including a memory and a processor learns a content generation model. The method includes preparing a training data set including multiple contents and a caption pair, learning a first machine learning model to restore the prepared contents from a low-dimensional latent code, learning a second machine learning model to output a latent code for a text embedding by learning a relationship between the latent code of the contents and the text embedding of the pair of captions of the contents, and combining the first machine learning model and the second machine learning model. The content is implicit data which is function-based 3D shape data.

In this case, the preparing the training data set including the multiple contents and the caption pair may further include converting the content into continuous function-based implicit data, when the content is 3D shape data in a point cloud format, a mesh format or a voxel format.

In addition, the learning the first machine learning model may include learning parameters of the first machine learning model so that the content is high-dimensional 3D shape data and the high-dimensional 3D shape data is compressed into a low-dimensional latent code.

In addition, the learning the first machine learning model may include learning to output the latent code by mapping structured data file (SDF) data, which is the high-dimensional 3D shape data of the content, with a low-dimensional latent space representation.

In addition, the learning the first machine learning model may include learning by reflecting Gaussian noise generated when learning the second machine learning model, when learning the first machine learning model.

In addition, the learning the second machine learning model may include inputting the caption to a text encoder to output a text embedding, and mapping the output text embedding with 3D shape data of the content which is the caption pair.

In addition, the learning the second machine learning model may include learning parameters of a diffusion model that converts the text embedding into a latent code through a forward diffusion process and a backward diffusion process.

In addition, the combining the first machine learning model and the second machine learning model may include repeatedly sampling data from the training data set for the first machine learning model and the second machine learning model, and repeatedly learning the first machine learning model and the second machine learning model, based on the sampled data.

In addition, according to an embodiment of the present disclosure, there is provided a method for generating contents through the content generation model of the computing system including the memory and the processor. The method includes acquiring a text prompt, inputting the acquired text prompt to a text encoder to output a text embedding, inputting the output text embedding to the second machine learning model to output a latent code, and inputting the output latent code to the first machine learning model to output the contents.

In this case, the inputting the output latent code to the first machine learning model may include outputting continuous SDF data from the first machine learning model, and converting the continuous SDF data into contents corresponding to the text prompt.

In addition, the converting the continuous SDF data into the contents may include converting the continuous SDF data into mesh data in accordance with a resolution of the text prompt, and converting the converted mesh data into point cloud data in accordance with the resolution of the text prompt.

In addition, according to an embodiment of the present disclosure, there is provided a system for generating contents. The system includes at least one memory; and at least one processor for providing a content generation service by reading at least one application stored in the memory.

Commands of the processor include acquiring a text prompt from a user input, inputting the acquired text prompt to a text encoder to output a text embedding, inputting the output text embedding to a diffusion model to output a latent code, inputting the output latent code to an SDF restoration model to output SDF data, and converting the output SDF data into contents corresponding to the text prompt.

A method and a system for generating text-based high-resolution 3D contents according to an embodiment of the present disclosure may provide high-dimensional 3D shape data in a compact low-dimensional latent space by utilizing a latent code which is a compressed representation of a shape to efficiently encode a complex 3D structure. Through this configuration, a content generation model may maintain a high resolution and shape detailed information without a high computational burden generally associated with large-scale 3D data. In particular, a first machine learning model may reduce the number of parameters, compared to conventional models that rely on large-scale 3D text learning data sets or heavy pre-trained backbones owing to compactness of a latent code representation of the SDF. Through this configuration, the first machine learning model may improve computationally efficiency. Moreover, the first machine learning model is suitable for a deployment on devices having a limited processing capability.

In addition, in a method and a system for generating text-based high-resolution 3D contents according to an embodiment of the present disclosure, robustness may be improved against noise generated during diffusion by reflecting and integrating noise of a learning process of a second machine learning model during latent space learning, and a complex shape may be accurately reconstructed under noisy or inaccurate conditions.

In addition, a method and a system for generating text-based high-resolution 3D contents according to an embodiment of the present disclosure may be highly adaptable and may generate shapes affected by various inputs including text, a class label, and an image. This flexibility may expand applicability to various fields from design to education, in which a user may generate a complex 3D model from the text prompt including a simple intention or various intentions.

However, advantageous effects achieved by the present disclosure are not limited to the above-described advantageous effects, and other advantageous effects which are not described herein may be clearly understood from the description below.

### BRIEF DESCRIPTION OF THE DRAWINGS

FIG. 1 illustrates a block diagram of a computing system configured to learn a text-based content generation model and perform a method for generating contents through the learned content model according to an embodiment of the present disclosure.

FIG. 2 illustrates a block diagram of a computing device configured to perform a method for generating contents corresponding to input text through a text-based content generation model according to an embodiment of the present disclosure.

FIG. 3 illustrates a block diagram in another aspect of a computing device configured to perform a method for generating contents corresponding to input text through a text-based content generation model according to an embodiment of the present disclosure.

FIG. 4 is a flowchart for describing a method for learning a text-based content generation model according to an embodiment of the present disclosure.

FIG. 5 is a flowchart of a method for generating contents through a text-based content generation model according to an embodiment of the present disclosure.

FIG. 6 is a block diagram illustrating a text-based content generation model according to an embodiment of the present disclosure.

FIG. 7 illustrates a process of converting function-based 3D shape data into high-resolution 3D contents according to an embodiment of the present disclosure.

### DETAILED DESCRIPTION

The present disclosure may be modified in various ways, and may adopt various embodiments. Therefore, specific embodiments will be illustrated in the accompanying drawings and described in detail. Advantageous effects and features of the present disclosure and methods for achieving the advantageous effects and the features of the present disclosure will become clear with reference to the embodiments described in detail below together with the drawings. However, the present disclosure is not limited to the embodiments disclosed below, and may be implemented in various forms. In the following embodiments, terms of first, second, and the like are not used in a limited sense but are used for the purpose of distinguishing one component from another component. In addition, a singular expression includes a plural expression unless the context clearly indicates otherwise. In addition, terms of including or having mean that the features or configuration elements described in the specification exist, and do not preclude a possibility that one or more other features or configuration elements may be added. In addition, sizes of the configuration elements in the drawings may be exaggerated or reduced for the convenience of description. For example, the size and a thicknesses of each configuration element illustrated in the drawings are optionally selected for the convenience of description. Therefore, the present disclosure is not necessarily limited to illustrated examples.

Hereinafter, embodiments of the present disclosure will be described in detail with reference to the accompanying drawings. When the embodiments of the present disclosure are described with reference to the drawings, the same reference numerals will be assigned to the same or corresponding configuration elements, and repeated descriptions thereof will be omitted.

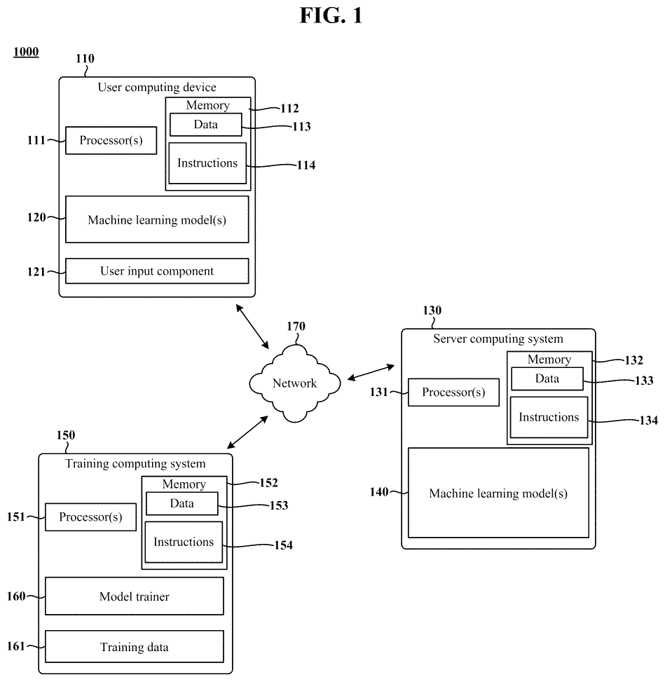

FIG. 1 illustrates a block diagram of a computing system configured to learn a text-based content generation model and perform a method for generating contents through the learned content model according to an embodiment of the present disclosure.

Referring to FIG. 1, a computing system 1000 configured to learn a text-based content generation model and perform a method for generating contents through the learned content model according to one embodiment of the present disclosure includes a user computing device or a user terminal 110, a training computing system or a computer 150, and a server computing system or a server 130, and each of the devices and the systems is communicatively connected via a network 170.

According to an embodiment of the present disclosure, 1) the user computing device 110 may perform a method for generating contents by using an internal and/or external machine learning model 120 or by using a machine learning model 140 provided by a server.

In addition, according to another embodiment of the present disclosure, 2) the server computing system 130 communicating with the user computing device 110 may provide a service for generating the contents to the user computing device 110 through an application and/or on the web in response to a request of a user via the user computing device 110.

In addition, according to still another embodiment of the present disclosure, 3) both the user computing device 110 and the server computing system 130 may provide the service for generating the contents to the user by performing at least a part of the method for generating the contents in conjunction with each other.

In addition, according to various embodiments of the present disclosure, the user computing device 110 and/or the server computing system 130 may learn the machine learning model 120 and/or 140 performed in the method for generating the contents through interaction with the training computing system 150 communicatively connected via the network 170. In this case, the training computing system 150 may be a system separate from the server computing system 130, or may be a part of the server computing system 130.

In some embodiments, the training computing system 150 may be a part of the server computing system 130, or may be a part of the user computing device 110.

Hereinafter, description is limited to an embodiment of performing a method for generating text-based contents by accessing the server computing system 130 through the user computing device 110, or performing a method for generating contents by directly storing and executing a content generation model in the user computing device 110.

However, in a case where it is described that a part of a process performed in the server computing system 130 is performed in the user computing device 110, as a matter of course, it may be understood that the case is included in the description of the present disclosure.

### User Computing Device 110

The user computing device 110 may include any type of computing devices or computers, such as a smart phone, a mobile phone, a digital broadcasting device, a personal digital assistant (PDA), a portable multimedia player (PMP), a desktop, a wearable device, an embedded computing device, and/or a tablet personal computer (PC).

In addition, in an embodiment, the user computing device 110 may further include a prescribed server computing device that provides a service environment for training a content generation model or generating contents through the content generation model.

The user computing device 110 includes at least one processor 111 and memory 112.

Here, the processor 111 may include one or more processors such as at least one or a plurality of electrically connected processors among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors and/or electrical units for performing other functions.

The memory 112 may include one or more non-transitory and/or transitory computer-readable storage media, such as a RAM, a ROM, an EEPROM, an EPROM, a flash memory device, a magnetic disk, and a combination thereof, and may include a web storage of a server performing a memory storage function on the Internet. The memory 112 may store data and commands which are required for at least one processor 111 to perform an operation of an application for performing the method for generating the contents.

In one embodiment, the user computing device 110 may perform various types of deep learning for a content generation service in conjunction with a deep-learning neural network.

Here, the deep-learning neural network according to an embodiment may include a convolutional neural network (CNN), an R-CNN (Regions with CNN features), a Fast R-CNN, a Faster R-CNN, a Mask R-CNN, and the like, and may include any deep-learning neural network including an algorithm capable of performing one or more embodiments described herein. The embodiment of the present disclosure is not limited or restricted to this deep-learning neural network.

In this case, depending on an embodiment, the deep-learning neural network may be directly installed in the server computing system 130, or may be operated as a device separate from the server computing system 130 to learn and execute the machine learning model for the content generation service.

In addition, in one embodiment, the user computing device 110 may store at least one machine learning model 120. For example, the user computing device 110 may include various machine learning models, such as a plurality of neural networks (for example, a Deep Neural Network) that perform at least a part of a process of generating contents, based on structured and/or quantitative data, or other types of machine learning models including non-linear models and/or linear models, and a combination thereof.

For example, the machine learning model may store a linear regression, a decision tree, a random forest, a language model in which gradient boosting is pre-trained, and/or a deep learning model. The neural network may include one or more of feed-forward neural networks, recurrent neural networks (for example, long short-term memory recurrent neural networks), convolutional neural networks and/or other forms of neural networks.

In another embodiment, the method for generating the contents requested through the user computing device 110 may be performed in such a way that the server computing system 130 performs at least a part of the method for generating the contents through at least one machine learning model 140 and a machine learning model of another server to provide data to the user computing device 110.

This user computing device 110 may include at least one input component 121 for detecting an input of the user. For example, the input component 121 may include a sensor system including an image sensor, a position sensor (IMU), an audio sensor, a distance sensor, a proximity sensor, a contact sensor, and the like.

For example, the user input component 121 may include a touch sensor (for example, a touch screen and/or a touch pad) for detecting touch of an input medium (for example, a finger or a stylus) of the user, an image sensor for detecting a motion input of the user, a microphone, a button, a mouse, and/or a keyboard for detecting a voice input of the user, and the like.

Here, the image sensor may include an image processing module or an image processor. In detail, the image sensor may process still images or moving images such as videos acquired by an image sensor device (for example, complementary metal oxide semiconductor (CMOS) or a charge-coupled device (CCD)).

In addition, the image sensor may extract necessary information, and may transmit the extracted information to the processor by processing the still images or the moving images acquired through the image sensor device by using an image recognition process (for example, OCR or the like) and/or an image processing module or an image processor.

In addition, the input component 121 may receive an input for an external controller (for example, a mouse, a keyboard, and the like), based on an interface module. In this case, the input component 121 may include an external output device (for example, a speaker).

In this case, the interface module may include one or more of a wired and/or wireless headset port, an external charger port, a wired and/or wireless data port, a memory card port, a port for connecting a device equipped with an identification module, an audio I/O (input/output) port, a video I/O (input/output) port, an earphone port, a power amplifier, an RF circuit, a transceiver, and other communication circuits.

In addition, the external output device may include a display system that outputs or display various information related to the content generation service, as graphic images.

The display system may be implemented by including at least one of a liquid crystal display (LCD), a thin film transistor-liquid crystal display (TFT LCD), an organic light-emitting diode (OLED), a flexible display, a 3D display, and an e-ink display.

Meanwhile, the user computing device 110 including the above-described configuration elements may be further configured to perform at least some of functional operations performed by the server computing system 130.

### Server Computing System 130

The server computing system 130 may perform a series of processes to learn the content generation model and to provide the content generation service through the learned content generation model.

In detail, in an embodiment, the server computing system 130 may provide the content generation service by exchanging data required for performing a service process for generating the contents with an external device such as the user computing device 110.

In more detail, in an embodiment, the server computing system 130 may provide an environment in which an application is operable in the user computing device 110.

For this purpose, the server computing system 130 may include application programs, data, and/or commands for operating the application, and may transmit and receive various data based thereon to and from the external device.

In addition, the server computing system 130 includes at least one processor 131 and memory 132. Here, the processor 131 may include one or more processors such as at least one or a plurality of electrically connected processors among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or electrical units for performing other functions.

The memory 132 may include one or more non-transitory and/or transitory computer-readable storage media, such as a RAM, a ROM, an EEPROM, an EPROM, a flash memory device, and a magnetic disk, and a combination thereof. The memory 132 may store data and commands which are required for the prompt template, the machine learning model 140, or the like in which the processor 131 performs a task through the language model of the server computing system 130 and/or the language model of the external server.

For example, the server computing system 130 may include a neural network and/or other multi-layer non-linear models as the machine learning model 140. Exemplary embodiments of the neural networks may include feed-forward neural networks, deep neural networks, recurrent neural networks, and convolutional neural networks.

In one embodiment, the server computing system 130 may include at least one computing device or computer. For example, the server computing system 130 may be configured to operate the plurality of computing devices in accordance with a sequential computing architecture, a parallel computing architecture, or a combination thereof. In addition, the server computing system 130 may include a plurality of computing devices or computers connected to a network.

In an embodiment, the server computing system 130 may further include a data store computing system 1000 (hereinafter, referred to as a “data store”), which is a storage for continuously storing and managing training data for learning the content generation model, and source data serving as a reference for a process for learning the content generation model and a method for generating the contents. This data store may include various forms of the data storage ranging from a file system to a cloud storage.

For example, the data store may include at least one database among a relational database that uses a structured query language (SQL) to define and manipulate data, a NoSQL database designed for flexibility and scalability to handle unstructured and semi-structured data, a data warehouse as a system used for reporting and data analysis, which is optimized for querying and analysis by centralizing a large amount of data from multiple sources, a data warehouse that stores a large amount of source data as native formats, such as structured data, semi-structured data, and unstructured data, a local storage device or a Network Attached Storage (NAS) that stores data in files, generally in a format accessible by a computer operating system.

### Training Computing System 150

The training computing system 150 includes at least one processor 151 and a memory 152. Here, the processor 151 may include one or more processors such as at least one or a plurality of electrically connected processors among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors and/or electrical units for performing other functions. The memory 152 may include one or more non-transitory and/or transitory computer-readable storage media such as a RAM, a ROM, an EEPROM, an EPROM, a flash memory device, a magnetic disk, and a combination thereof. The memory 152 may store data and commands which are required for the processor 151 to train the machine learning model.

For example, the training computing system 150 may include a model trainer 160 that trains the machine learning model stored in the user computing device 110 and/or the server computing system 130 by using various training or learning techniques, such as error backpropagation.

For example, the model trainer 160 may perform one or more parameter updates of the machine learning model that restores a latent code to function-based content data in a backpropagation manner, based on an objective function optimized for restoring the function-based content data from the latent code and a defined loss function.

In some embodiments, performing the error backpropagation may include performing truncated backpropagation through time. The model trainer 160 may perform the plurality of generalization techniques (for example, weight decay, dropout, knowledge distillation, or the like) to improve the generalization ability of the trained machine learning model.

The model trainer 160 includes a computer logic utilized to provide a desired functionality. The model trainer 160 may be implemented in hardware, firmware and/or software that controls a general-purpose processor. For example, in one embodiment, the model trainer 160 may include a program file stored in a storage device, may be loaded into a memory, and may be executed by one or more processors. In another embodiment, the model trainer 160 includes one or more sets of computer-executable commands stored in a tangible computer-readable storage medium, such as a RAM hard disk or an optical or magnetic medium.

Without being limited, the network 170 includes a 3rd Generation Partnership Project (3GPP) network, a Long Term Evolution (LTE) network, a World Interoperability for Microwave Access (WIMAX) network, the Internet, a Local Area Network (LAN), a Wireless Local Area Network (Wireless LAN), a Wide Area Network (WAN), a Personal Area Network (PAN), a Bluetooth network, a satellite broadcast network, an analog broadcast network, and/or a Digital Multimedia Broadcasting (DMB) network.

In general, communication through the network 170 may be performed by using any type of wired and/or wireless connection, through various communication protocols (for example, TCP/IP, HTTP, SMTP, and FTP), encodings or formats (for example, HTML and XML), and/or protection schemes (for example, VPN, Secure HTTP, and SSL).

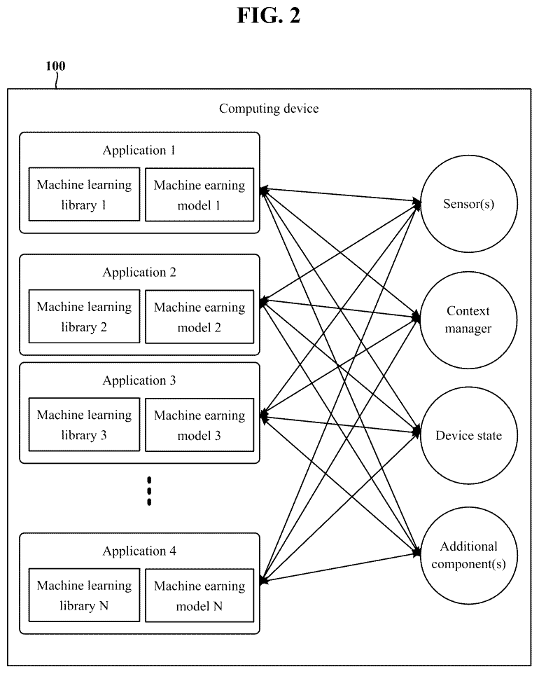

FIG. 2 illustrates a block diagram of a computing device, which is one of configuration elements of the computing system 1000 that performs a method for generating contents according to an embodiment of the present disclosure.

Referring to FIG. 2, the computing device 100 included in the user computing device 110, the server computing system 130, and the training computing system 150 of FIG. 1 includes multiple applications (for example, Application 1 to Application N). Each application may include a machine learning library. For example, the application may include a content generation application configured to generate contents corresponding to an input text, a browser application, a chat-bot application, and the like.

In an embodiment, the computing device 100 may include the model trainer 160 for training the machine learning model, and may perform the method for generating the contents for the input data by storing and operating the machine learning model.

For example, each application of the computing device 100 may communicate with other multiple components of the computing device, such as one or more sensors, a context manager, a device state component, and/or an additional component. In one embodiment, each application may communicate with each device component by using an application programming interface (API) (for example, a public API). In one embodiment, the API used by each application may be specific to the corresponding application.

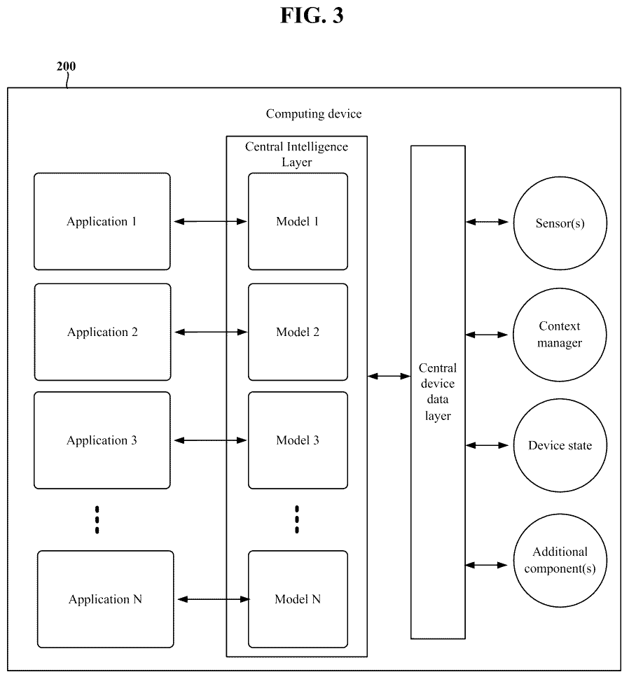

FIG. 3 illustrates a block diagram in another aspect of the computing device, which is one of the configurations of the computing system 1000 that performs a method for generating contents according to an embodiment of the present disclosure.

Referring to FIG. 3, a computing device 200 includes multiple applications (for example, Application 1 to Application N). Each application may communicate with a central intelligence layer. For example, the application may include a content generation application, a text messaging application, an email application, a dictation application, a virtual keyboard application, a browser application, and the like. In one embodiment, each application may communicate with the central intelligence layer (and models stored therein) by using an API (for example, a common API across all applications).

The central intelligence layer may include prompts using multiple machine learning models and/or language models. For example, as illustrated in FIG. 3, each machine learning model and at least some of the machine learning models may be provided for each application, and may be managed by the central intelligence layer. In other embodiments, two or more applications may share a single machine learning model. For example, in some embodiments, the central intelligence layer may provide a single model for all applications. In some embodiments, the central intelligence layer may be included in an operating system of the computing device 200, or may be implemented otherwise.

The central intelligence layer may communicate with a central device data layer. The central device data layer may be a centralized data storage for the computing device 200. As illustrated in FIG. 3, for example, the central device data layer may communicate with other multiple components of the computing device, such as one or more sensors, a context manager, a device state component, and/or an additional component. In some embodiments, the central device data layer may communicate with each device component by using an API (for example, a private API).

The technology described herein may refer to servers, databases, software applications, and other computer-based systems, as well as taken actions and information transmitted to or from the systems. It will be appreciated that inherent flexibility of the computer-based systems allows functionality among a wide range of possible configurations, combinations, task divisions, and components, and functionality therefrom. For example, the processes described herein may be implemented by using a single device or component, multiple devices or components operated in combination. The databases and the applications may be implemented in a single system or in a system distributed across multiple systems. Distributed components may be operated sequentially or in parallel.

### Method for Learning Text-Based Content Generation Model

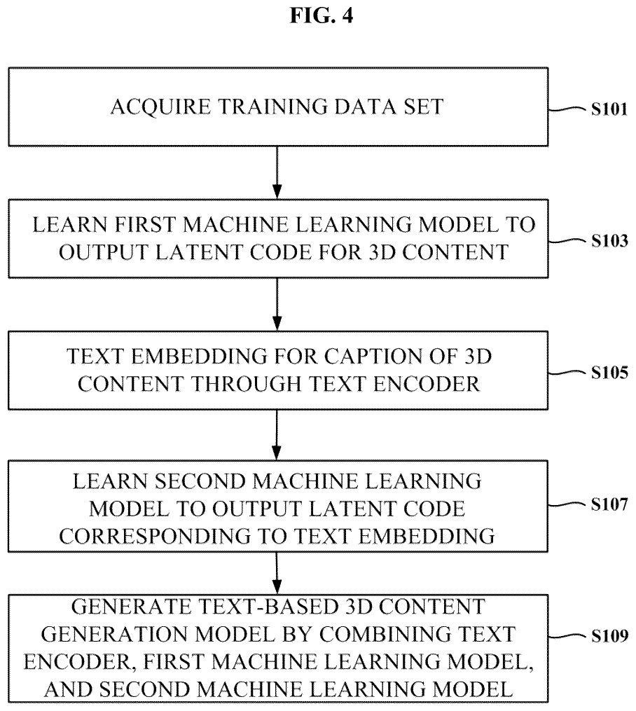

Hereinafter, a method in which the computing system 1000 according to an embodiment of the present disclosure learns the content generation model for generating the contents corresponding to the text will be described with reference to FIG. 4.

FIG. 4 is a flowchart illustrating a method for learning a text-based content generation model according to an embodiment of the present disclosure.

Referring to FIG. 4, at step S101, the computing system 1000 may prepare a training data set for learning a content generation model.

The training data set may include multiple contents and captions mapped to each of the contents.

Here, the content may include 3D shape data that represents a 3D shape on a computer.

For example, the content may be at least one of point cloud data representing a 3D shape as points, mesh data representing the 3D shape as a surface such as a triangle and representing the 3D shape as a surface such as a quadrangle, voxel data representing the 3D shape by dividing the 3D shape into grids, and implicit data representing the 3D shape through a function.

Here, the implicit data may be a data format suitable for generating 3D shape data with a small processing capacity, since the implicit data may continuously and smoothly implement the 3D shape by representing the 3D shape through the function.

The temporary data include SDF data and Occupancy data. In the embodiment, the SDF data will be described as a representative example, but any data format representing the 3D shape through the function may be applicable to the present disclosure.

In detail, the SDF data is a function of representing a closest distance from each coordinate in a space to a surface of the 3D shape, and may mean a function having signs added according to an inside, an outside, and a surface of the 3D shape. Continuous SDF may be optimized for implementing high-resolution 3D shape. That is, in the embodiment, the first machine learning model that outputs the SDF data may be DeepSDF.

Accordingly, when the 3D shape data is the implicit data, the computing system 1000 may use the 3D shape data included in the contents as it is, and when the 3D shape data is point cloud, mesh, or voxel data, the computing system 1000 may perform a data preparation task by using an additional model that converts the 3D shape data into the continuous SDF data.

The training data set may include captions describing the matched content or having information regarding relation with the content.

For example, the caption may include at least one text that indicates features of the contents, such as a class, an attribute, a shape, a type, and a name.

In detail, the caption may include a text that represent an overall shape of the content, a text that represents a detailed shape, a text that represents a texture, a color, a size, a style, a detailed form, and the like, and a text that represents attributes of the content, such as a name, a category, a type, a domain, and the like of the content.

At step S103, when the training data set is prepared, the computing system 1000 may learn the first machine learning model to output the latent code for the content.

Here, the latent code may be a vector representing a geometrical feature of a 3D object of 3D contents.

The latent code is data including relatively low-dimensional data compared to the implicit data, and compressing and representing information such as a shape, a size, and a style of the implicit data of the 3D shape.

In an embodiment, the first machine learning model may be trained to learn a complex 3D structure and shape of the 3D object represented by multiple SDF data and to transform or inversely transform the complex 3D structure and shape of the 3D object into low-dimensional latent code representations.

In an embodiment, zi is described as a 256-dimensional vector, which is a number derived from an experiment and is a number of dimensions suitable for learning shape features of objects in the SDF data while the amount of data processing is minimized (in general, since dimensions of high-resolution 3D shape data are 1,048,576 dimensions, it is desirable to set dimensions of the latent code to a ratio of approximately 1/4000.)

Hereinafter, a process of learning the first machine learning model will be described in more detail.

### Method for Learning First Machine Learning Model

First, a process of deriving an optimized objective equation and a loss function for a relationship between the SDF data and the latent code will be described.

When the SDF data is {SDFi, i=1, . . . , N}, the SDF data may be represented by Equation 1.

$${S}_{i} = {\{ ( {c}_{j} , {s}_{j} ) , {c}_{j} = ( {c}_{j}^{x} , {c}_{j}^{y} , {c}_{j}^{z} ) \}}_{j = 0}^{{K}_{train}} \qquad [ Equation 1 ]$$

In detail, the SDF data is Si={(cj, sj)}, where i is a number of the content included in the training data set, and

$${c}_{□} = ( {c}_{j}^{x} , {c}_{j}^{y} , {c}_{j}^{z} )$$

is a 3D coordinate of sampled query points, Sj is a value of the SDF, which is a signed distance between the query points and surfaces of the 3D shape, and means the number of points sampled during Ktrain.

Before the learning, a latent code zi mapped to each SDF data is initialized from a normal distribution, and each SDF data may form a pair with each latent code zi. That is, the latent code is {zi, i=1, . . . , N}, and may be represented by Equation 2.

$$p ( {z}_{□} ) = N ( 0 , {σ}^{2} I ) \qquad [ Equation 2 ]$$

Since the first machine learning model has to be trained to restore si when zi is input, a posterior distribution may be derived as in Equation 3 below, based on a prior probability distribution and likelihood by using Bayes' theorem.

$${S}_{□} : {p}_{θ} ( {z}_{i} \vert {S}_{i} ) = p ( {z}_{i} ) {\prod }_{( {c}_{□ ;} {s}_{i} ) ∈ {S}_{i}} {p}_{θ} ( {s}_{j} \vert {z}_{i} ; {c}_{j} ) \qquad [ Equation 3 ]$$

That is, Equation 3 that makes zi as similar as possible to the representation of si may be derived.

A first machine learning model (fθ) may be re-parameterized to predict that an output value is si for an input of zi in a case of a neural network having a learnable parameter θ.

$${p}_{□} ( {s}_{j} \vert {z}_{i} ; {c}_{j} ) = exp ( - ℒ ( {f}_{θ} ( {z}_{i} , {c}_{j} ) , {s}_{j} ) ) \qquad [ Equation 4 ]$$

For optimization, a loss of an output of the first machine learning model and regularization of the latent code may be combined to derive an optimization objective function as in Equation 5.

$${arg min}_{θ , {\{ {z}_{◻} \}}_{i = 1}^{N}} {\sum }_{i = 1}^{N} ( {\sum }_{j = 1}^{{K}_{train}} ℒ ( {f}_{θ} ( {z}_{i} , {c}_{j} ) , {s}_{j} ) + ω {‖ {z}_{i} ‖}_{2}^{2} ) \qquad [ Equation 5 ]$$

Here, ω is a hyperparameter that controls the regularization, and L(fθ(zi,cj),sj) is defined as a loss function. The loss function is |clamp(fθ(x),δ)−clamp(s,δ), and a clamp operation limits a value of the SDF near an object surface.

The computing system 1000 may learn the first machine learning model through Equations 1 to 4 for a relationship between the SDF data and the latent code in the training data set, and may train the first machine learning model to restore the corresponding SDF data when the latent code zi is input.

In this case, when learning the first machine learning model, Gaussian noise may be added during a learning operation to ensure robustness against noise which may be generated when the second machine learning model is a diffusion model later.

To describe a learning process in more detail, the computing system 1000 may add the Gaussian noise to z0 sampled from the prior distribution through a forward diffusion process.

$$q ( {z}_{0 : T} ) = q ( {z}_{0} ) {\prod }_{t = 1}^{T} q ( {z}_{t} \vert {z}_{t - 1} ) \qquad [ Equation 6 ]$$

Here, q(zt|z(t−1)) is the Gaussian noise added to the latent code at each time operation or step.

In more detail, the computing system 1000 may perform a process by modeling a diffusion process so that the Gaussian noise added at each time step is defined as in Equation 7 below.

$$q ( {z}_{□} \vert {z}_{t - 1} ) = N ( \sqrt{1 - {β}_{t}} {z}_{t - 1} , {β}_{t} I ) \qquad [ Equation 7 ]$$

Here, βt is a parameter that controls a noise level at each operation, and may mean an output of the second machine learning model for the text embedding of the caption.

Next, the computing system 1000 may reconstruct the SDF sample by restoring the latent code from a standard Gaussian prior distribution through a reverse diffusion process. That is, through this process, the computing system 1000 reconstructs a shape of the SDF sample by reflecting the parameter in the latent code-based first machine learning model.

An example of the equation applied to the reverse diffusion process is defined as in Equation 8 below.

$${p}_{□} ( {z}_{0 : T} ) = p ( {z}_{T} ) {\prod }_{t = 1}^{T} {p}_{θ} ( {z}_{t - 1} \vert {z}_{t} ) \qquad [ Equation 8 ]$$

Finally, the computing system 1000 may sample the latent code by using Langevin dynamics after a parameter gθ of the second machine learning model is trained for all learned latent codes. Here, the sampled latent code is used as a conditional input to the latent code-based SDF model for new shape reconstruction.

The sampling equation is defined as in Equation 9.

$${z}^{t - 1} = \frac{1}{\sqrt{{a}_{t}}} ( {z}^{t} - \frac{1 - {a}_{t}}{\sqrt{1 - {\overline{a}}_{t}}} {g}_{θ} ( {z}^{t} , t ) ) + \sqrt{{β}_{t}} ϵ \qquad [ Equation 9 ]$$

Here, ε˜N(0,1) means standard Gaussian noise.

The computing system 1000 may train the first machine learning model to generate the latent code for the 3D shape of the SDF data by repeatedly performing a sampling process and a diffusion process, and to precisely restore the 3D shape of the existing SDF data through the generated latent code.

The first machine learning model generated in this way according to the embodiment may represent high-dimensional 3D shape data in a compact low-dimensional latent space by utilizing the latent code which is a compressed representation of shape to efficiently encode a complex 3D structure. Through this configuration, the content generation model may maintain a high resolution and shape detailed information with less computation resources or without a computational burden generally associated with large-scale 3D data. This first machine learning model may reduce the number of parameters, compared to conventional models that rely on large-scale 3D text learning data sets or heavy pre-trained backbones owing to compactness of the latent code representation of the SDF. Through this configuration, the first machine learning model may improve computational efficiency. Moreover, the first machine learning model is suitable for a deployment on devices having a limited processing capability.

At step S107, when the first machine learning model is trained, the computing system 1000 may learn the second machine learning model to convert the text embedding into the latent code.

That is, the second machine learning model may be a model trained to output the latent code in which information on the 3D shape is compressed, when the text embedding of the text prompt for representing the 3D shape is input.

### Method for Learning Second Machine Learning Model

The second machine learning model is a model trained to output the latent code for the input of the text embedding by learning a relationship between the latent code and the text embedding of a matched pair.

The second machine learning models are generative models, and at least one of generative adversarial networks (GANs), autoencoders (VAEs), diffusion models, and transformer-based generative models may be used as the second machine learning models. However, for illustration purposes only, the description for an embodiment of the present disclosure will be continued by limiting the second machine learning model to a diffusion model suitable for high-resolution content generation, which is a model that generates data while gradually removing noise and which shows an advantage in high-resolution image generation.

First, the computing system 1000 may acquire the text embedding for the caption in the training data set through a separate text encoder.

For instance, the computing system 1000 may input the text included in the caption to the text encoder, and may convert each token and a sequence between the tokens into a learnable embedding vector.

In an embodiment, the computing system 1000 may convert the sequence between the tokens by using a Byte Pair Encoding (BPE) method, may maintain the learnable embedding for each unique token during the learning process, and may generate the text embedding through this process. This embedding may be acquired by combining the embeddings of all tokens of the corresponding text description.

The computing system 1000 may match the latent code and the text embedding.

In detail, the training data set includes a pair of the caption and the content, and the latent code and the text embedding of the caption for the SDF data of the content corresponding to each pair may be acquired in pairs.

Therefore, the forward diffusion process for the diffusion model may be derived by Equation 10, and the backward diffusion process may be derived by Equation 11.

$$q ( {z}_{□}^{t} \vert {z}_{i}^{t - 1} , {B}_{i}^{ϕ} ) \qquad [ Equation 10 ]$$

$${p}_{□} ( {z}_{i}^{t - 1} \vert {z}_{i}^{t} , {B}_{i}^{ϕ} ) \qquad [ Equation 11 ]$$

Here, Bi represents the text embedding, and 0 represents parameterization of the second machine learning model.

When defined in this way, the computing system 1000 may learn parameters according to Equation 12 which is a learning objective.

$${min}_{θ , ϕ} {‖ ϵ - {g}_{□} ( {z}_{i}^{t} , {B}_{i}^{ϕ} , t ) ‖}^{2} , ϵ ∼ N ( 0 , I ) \qquad [ Equation 12 ]$$

As described above, at step S109, the computing system 1000 may repeatedly sample data from the training data set, may repeatedly learn the first machine learning model and the second machine learning model, may finally complete the learning of the first machine learning model and the second machine learning model, and may naturally combine the first machine learning model and the second machine learning model to generate the content generation model.

The first machine learning model according to an embodiment of the disclosure is trained by reflecting and integrating the noise of the learning process of the second machine learning model during latent space learning. In this manner, robustness against noise generated during diffusion may be improved, and a complex shape may be accurately reconstructed under noisy or inaccurate conditions.

In addition, the content generation model including the first machine learning model and the second machine learning model according to an embodiment of the present disclosure is highly adaptable, and may generate shapes affected by various inputs including a text, a class label, and an image. This flexibility may expand applicability to various fields from design to education, in which a user may generate a complex 3D model from the text prompt including a simple intention or various intentions.

### Method for Generating Content Through Content Generation Model

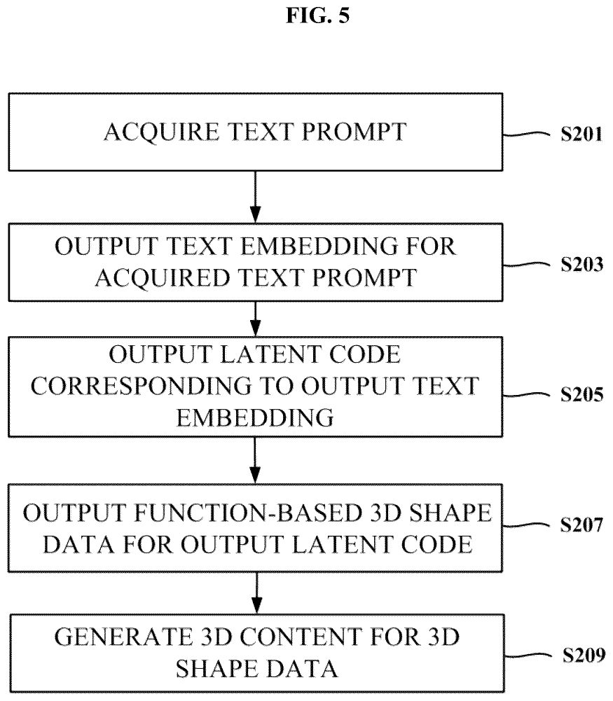

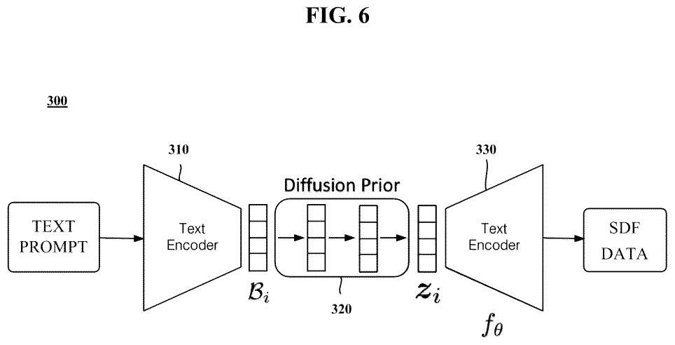

Hereinafter, referring to FIGS. 5 to 7, a process of generating high-resolution content corresponding to a text prompt by inputting a desired intention of a user through the content generation model 300 according to an embodiment of the present disclosure will be described.

First, at step S201, the computing system 1000 may acquire the text prompt when the user inputs the text prompt through the user computing device 100.

For instance, the text prompt may include the text for at least one of a class, an attribute, a shape, a type, and a name of the content to be generated.

In addition, the text prompt may include the text for inputting a corresponding value after specifying at least one of a category, a size, a style, a data format, and a resolution.

Specifically, the computing system 1000 may acquire the text prompt in a form of a chat or voice conversation with the user, including a language model.

In this case, the computing system 1000 may exchange multiple conversations with the language model instead of a one-time test input from the user. Thereafter, the language model may generate the text prompt from the conversation by detecting the context of the conversation.

For this purpose, the language model of the computing system 1000 may organize and provide the text prompt generated based on the context of the conversation to be confirmed before the 3D content is generated. That is, the computing system 1000 may organize the text for a preset caption category based on the context of the conversation, may provide the organized text to the user as the text prompt, and may finally receive a confirmation of whether or not to generate the text prompt.

In addition, the computing system 1000 may conduct a conversation through the language model so that the user may additionally determine incidental features of the data providing the generated 3D content, such as a data size, a scale, a data format, and a resolution, in addition to the caption regarding the shape of the 3D content.

In this way, the computing system 1000 may acquire an intention of the user through the conversation of the language model in a form of the text prompt optimized for a pre-constructed content restoration model, may quickly satisfy content generation quality and the intention of the user, and may avoid performing an unnecessary and repetitive 3D content generation task.

Thereafter, at step S203, the computing system 1000 may input the input text prompt to the text encoder 310, and may output the text embedding.

Next, at step S205, the computing system 1000 may input the text embedding to the second machine learning model 320, and may output the latent code corresponding to the text embedding.

At step S207, the computing system 1000 may input the output latent code to the first machine learning model 330, and may restore the latent code to the 3D shape data.

In this case, the restored 3D shape data may be the implicit data which is function-based 3D shape data. For example, in an embodiment, the restored 3D shape data may be a continuous function and distance-based continuous SDF data.

Thereafter, at step S209, the computing system 1000 may additionally process the implicit data into the 3D object, and may generate the high-resolution content.

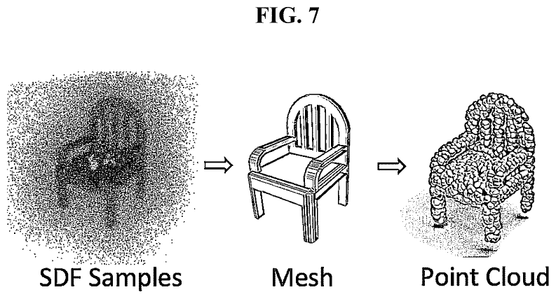

In detail, referring to FIG. 7, when the text prompt includes a request for a mesh format, a point cloud format, or a resolution, the content corresponding to the request may be generated through a 3D object processing module.

In general, the computing system 1000 may convert the continuous SDF data having less resolution restrictions into the mesh format to generate the high-resolution content, thereafter, may convert the mesh format again into the point cloud format data with the desired resolution, and may finally generate the high-resolution content.

That is, the computing system 1000 may determine whether to apply an additional module by identifying the intention of the user from the text prompt, including an SDF-mesh data conversion module and a mesh-point cloud conversion module, and may generate and provide the content optimized for the intention of the user.

Table 1 and Table 2 below show advantageous effects by comparing various machine learning models that output the 3D shape by using the input of the text with the content generation model 300 of an exemplary embodiment of the present disclosure (denoted as CDiffSDF).

TABLE 1

| Dataset | Method | IoU↑ | FID↓ | MMD↓ | TMD↑ |
|---|---|---|---|---|---|
| ShapeGlot | CWGAN | 0.098 | 121.7 | 22.46 | 0.67 |
| | Shape IMLE | 0.153 | 87.9 | 12.37 | 1.83 |
| | CLIP-Forge | 0.052 | 94.5 | 36.43 | 2.45 |
| | Shape Compiler | — | — | 6.19 | 1.85 |
| | VoxelDiffSDF | 0.207 | 76.2 | 7.35 | 2.41 |
| | CDiffSDF | 0.196 | 73.4 | 6.42 | 2.87 |
| Text2shape | CWGAN | 0.127 | 113.2 | 10.42 | 0.79 |
| | Shape IMLE | 0.165 | 98.4 | 6.73 | 2.34 |
| | CLIP-Forge | 0.114 | 92.5 | 5.16 | 1.34 |
| | Shape Compiler | — | — | 6.21 | 1.53 |
| | VoxelDiffSDF | 0.214 | 90.2 | 4.23 | 2.25 |
| | CDiffSDF | 0.231 | 87.3 | 4.41 | 2.17 |
| ABO | CWGAN | 0.132 | 89 | 12.74 | 0.52 |
| | Shape IMLE | 0.196 | 86.3 | 6.43 | 1.42 |
| | CLIP-Forge | 0.147 | 75.4 | 7.89 | 1.23 |
| | Shape Compiler | — | — | 4.93 | 0.67 |
| | VoxelDiffSDF | 0.235 | 59.6 | 5.21 | 1.53 |
| | CDiffSDF | 0.253 | 56.7 | 4.71 | 1.36 |

TABLE 2

| Methods | Enc. Params. | Gen. Params. | Speed(s)↓ |
|---|---|---|---|
| Dream Fields | — | 149,691,777 | >10000 |
| Dream Fusion¹ | — | 1,289,952,427 | 2432.72 |
| CWGAN | 4,183,618 | 44,101,313 | 4.24 |
| Shape IMLE | 11,149,824 | 117,534,920 | 1007.48 |
| CLIP-Forge | 5,409,665 | 18,373,120 | 1.45 |
| Shape Compiler | 26,795,008 | 36,741,120 | 6.43 |
| Point-E² | — | 80,804,376 | 28.17 |
| Shap-E(stf) | 443,771,357 | 315,692,032 | 16.18 |
| Shap-E(nerf) | 443,771,357 | 315,692,032 | 192.62 |
| SDFusion | 26,349,788 | 413,540,739 | 9.12 |
| VoxelDiffSDF | 13,415,497 | 465,902,920 | 8.41 |
| CDiffSDF | 3,354,502 | 3,904,640 | 1.87 |

Table 1 shows MMD (quality) and TMD (diversity), and a speed in Table 2 shows a processing speed. Tables 1 and 2 above show that the content generation model 300 (CDiffSDF) according to an exemplary embodiment of the present disclosure shows relatively better performance in various measurement factors.

Some embodiments according to the present disclosure described above may be implemented in a form of program commands that may be executed through various computer configuration elements, and may be recorded on a computer-readable recording medium. The computer-readable recording medium may include program commands, data files, data structures, and the like alone or in combination. The program commands recorded on the computer-readable recording medium may be specially designed and configured for the present disclosure, or may be known and available to those skilled in the art of computer software. Examples of the computer-readable recording medium include magnetic media such as hard disks, floppy disks, and magnetic tapes, optical recording media such as CD-ROMs and DVDs, magneto-optical media such as floptical disks, and hardware devices specially configured to store and execute the program commands, such as ROMs, RAMs, and flash memories. Examples of the program commands include not only machine language codes generated by a compiler, but also high-level language codes that may be executed by a computer by using an interpreter or the like. The hardware device may be changed to one or more software modules to perform processing according to the present disclosure, and vice versa.

The specific embodiments described in the present disclosure are merely examples, and do not limit the scope of the present disclosure in any way. In order to simplify the present specification, electronic configuration elements, control systems, software, and other functional aspects of the systems may be omitted in the description. In addition, connections or connection members of lines between the configuration elements illustrated in the drawings are examples of functional connections and/or physical connections or circuit connections, and may be replaced or represented as various additional functional connection, physical connections, or circuit connections in an actual device. In addition, when there is no specific description such as “essential” and “important”, the configuration elements may not be absolutely necessary for the application of the present disclosure.

In addition, although the detailed description of the present disclosure has been described with reference to the preferred embodiments of the present disclosure, it will be understood by those skilled in the art or those with common knowledge in the art that the present disclosure may be corrected and modified in various ways within the scope that does not depart from the concept and the technical idea of the present disclosure described in the appended claims. Therefore, the technical scope of the present disclosure should not be limited to the contents described in the detailed description of the present specification, but should be defined by the appended claims.

What is claimed is:

1. A method for learning a content generation model configured to generate content for an input text, the method comprising:
preparing a training data set including a plurality of pairs of contents and captions;
learning a first machine learning model to restore the contents from a low-dimensional latent code;
learning a second machine learning model to output a latent code for a text embedding by learning relationship between text embeddings and latent codes of the pairs of the contents and the captions; and
combining the first machine learning model and the second machine learning model,
wherein the contents are implicit data which is function-based three-dimensional (3D) shape data.

2. The method of claim 1, wherein the preparing of the training data set including the plurality of pairs of the contents and the captions includes converting the contents into continuous function-based implicit data when the contents are 3D shape data in a point cloud format, a mesh format or a voxel format.

3. The method of claim 1, wherein:
the contents are high-dimensional 3D shape data, and
the learning of the first machine learning model includes learning parameters of the first machine learning model so that the high-dimensional 3D shape data is to be compressed into the low-dimensional latent code.

4. The method of claim 1, wherein the learning of the first machine learning model includes mapping structured data file (SDF) data, which is high-dimensional 3D shape data of the contents, with low-dimensional latent space representation to learn the first machine learning model to output the latent code for the text embedding.

5. The method of claim 3, wherein the learning of the first machine learning model includes reflecting Gaussian noise, generated when learning the second machine learning model, when learning the first machine learning model.

6. The method of claim 1, wherein the learning of the second machine learning model includes inputting the captions to a text encoder to output the text embeddings, and mapping the output text embeddings with 3D shape data of the contents which are paired with the captions.

7. The method of claim 6, wherein the learning of the second machine learning model includes learning parameters of a diffusion model configured to convert the text embedding into the latent code through a forward diffusion process and a backward diffusion process.

8. The method of claim 7, wherein the combining of the first machine learning model and the second machine learning model includes repeatedly sampling data from the training data set for the first machine learning model and the second machine learning model, and repeatedly learning the first machine learning model and the second machine learning model using the sampled data.

9. A method for generating the contents using the content generation model learned by the method of claim 1, comprising:
acquiring a text prompt;
inputting the acquired text prompt to a text encoder to output the text embedding;
inputting the output text embedding to the second machine learning model to output the latent code for the text embedding; and
inputting the output latent code for the text embedding to the first machine learning model to output the contents.

10. The method of claim 9, wherein the inputting of the output latent code for the text embedding to the first machine learning model includes outputting continuous SDF data from the first machine learning model, and converting the continuous SDF data into contents corresponding to the text prompt.

11. The method of claim 10, wherein the converting of the continuous SDF data into the contents corresponding to the text prompt includes converting the continuous SDF data into mesh data in accordance with a resolution of the text prompt, and converting the converted mesh data into point cloud data in accordance with the resolution of the text prompt.

12. A system comprising:
memory configured to store instructions; and
one or more processors configured to be operable to execute the instructions to: acquire a text prompt from a user input;
input the acquired text prompt to a text encoder to output a text embedding;
input the output text embedding to a diffusion model to output a latent code;
input the output latent code to an SDF restoration model to output SDF data; and
convert the output SDF data into contents corresponding to the text prompt.

13. A computerized method comprising:
acquiring a text prompt from a user input;
inputting the acquired text prompt to a text encoder to output a text embedding;
inputting the output text embedding to a diffusion model, and outputting a latent code for representing a shape feature of 3D shape contents to be generated corresponding to the text embedding in the diffusion model; and
inputting the output latent code to a 3D shape restoration model, and generating the 3D shape contents corresponding to the text embedding through the 3D shape restoration model.

14. The method of claim 13, wherein the acquiring of the text prompt from the user input includes acquiring text from one or more of a class, an attribute, a shape, a type, or a name of the 3D shape contents to be generated, and acquiring text for inputting a value corresponding to selection of one or more of a category, a size, a style, a data format, or a resolution of the 3D shape contents to be generated.

15. The method of claim 14, wherein the outputting of the latent code for representing the shape feature of the 3D shape contents includes converting a 3D shape corresponding to the text acquired from the one or more of the class, the attribute, the shape, the type, or the name of the 3D shape contents into a low-dimensional latent code.

16. The method of claim 15, wherein the generating of the 3D shape contents corresponding to the text embedding includes outputting an external shape of the 3D shape, corresponding to the output latent code in the 3D shape restoration model, as function data defined as a function, and restoring the 3D shape contents based on the output function data with reference to one or more of the category, the size, the style, the data format, or the resolution which are included in the text prompt.

17. The method of claim 16, wherein the outputting of the external shape of the 3D shape, corresponding to the output latent code in the 3D shape restoration model, as the function data defined as the function includes outputting the function data based on a continuous function of defining a distance from a surface of the external shape of the 3D shape to a reference point.

18. The method of claim 14, wherein the acquiring of the text prompt from the user input includes extracting text corresponding to the text prompt from one or more conversations between a user and a language model.

19. The method of claim 18, wherein the extracting of the text corresponding to the text prompt from the one or more conversations includes determining context-based text related to content generation from the one or more conversations including text inputs of the user and responses to the language model for each caption category.

20. The method of claim 19, wherein the extracting of the text corresponding to the text prompt from the one or more conversations further includes receiving confirmation of whether or not to generate the contents after providing the user with the text prompt including the texts determined for the each caption category.
